(19) United States
(12) Patent Application Publication
(10) Pub. No.: US 2023/0022637 A1
(43) Pub. Date: Jan. 26, 2023

(54) INFORMATION PROCESSING APPARATUS, INFORMATION PROCESSING METHOD, AND PROGRAM

(71) Applicant: SONY GROUP CORPORATION, TOKYO (JP)

(72) Inventor: KEIJI MURO, TOKYO (JP)

(21) Appl. No.: 17/756,153

(22) PCT Filed: Nov. 17, 2020
(86) PCT No.: PCT/JP2020/042716

§ 371 Date: May 18, 2022

(30) Foreign Application Priority Data
Nov. 28, 2019 (JP) 2019-214807

(51) Int. Cl. G05D 1/02

(52) U.S. Cl. CPC G05D 1/0214; G05D 1/0223

(57) ABSTRACT

An information processing apparatus according to an embodiment of the present technology includes a sub-goal setting unit, a local-route planning unit, and a speed planning unit. The sub-goal setting unit sets a sub-goal on the basis of environment information including position information of a set destination, map information of a travel environment of a mobile apparatus, and self-position information of the mobile apparatus. The local-route planning unit plans a movement route of the mobile apparatus on the basis of the sub-goal. The speed planning unit plans a speed of the mobile apparatus at an end point of a route extended by a predetermined length from the sub-goal.

### TECHNICAL FIELD

The present technology relates to an information processing apparatus, an information processing method, and a program for controlling an autonomous-type mobile apparatus.

### BACKGROUND ART

In recent years, autonomous-type mobile apparatuses including, for example, self-driving cars, robots, and the like have been actively developed. In order for such a mobile apparatus to move following a predetermined route to a destination, it is necessary move the mobile apparatus while avoiding obstacles on the route.

For example, Patent Literature 1 has disclosed an autonomous mobile robot apparatus as such a technology, the autonomous mobile robot apparatus including a route generating unit for setting a route to reach a destination while avoiding a detected obstacle on the basis of a predetermined avoiding method, together with a speed, and being configured to control the route and the speed so as to avoid collision with the obstacle that jumps out from a blind spot in its travel direction.

### CITATION LIST

### Patent Literature

Patent Literature 1: Japanese Patent No. 4717105

### DISCLOSURE OF INVENTION

### Technical Problem

This kind of mobile apparatus is required to smoothly move from a departure place to a destination. Therefore, in a case where collision with the obstacle is predicted, a route has to be planned so that the mobile apparatus can stop at a pre-set deceleration speed. However, Patent Literature 1 has not described a case where collision with the obstacle cannot be avoided, that is, a case where a detour route cannot be generated, and in such a case, an unsmooth response such as rapid deceleration can occur.

In view of such circumstances, it is an objective of the present technology to provide an information processing apparatus, an information processing method, and a program that are capable of suppressing the occurrence of an unsmooth response such as rapid deceleration.

### Solution to Problem

An information processing apparatus according to an embodiment of the present technology includes a sub-goal setting unit, a local-route planning unit, and a speed planning unit.

The sub-goal setting unit sets a sub-goal on the basis of environment information including position information of a set destination, map information of a travel environment of a mobile apparatus, and self-position information of the mobile apparatus.

The local-route planning unit plans a movement route of the mobile apparatus on the basis of the sub-goal.

The speed planning unit plans a speed of the mobile apparatus at an end point of a route extended by a predetermined length from the sub-goal.

The local-route planning unit may be configured to plan a local route including the route extended by the predetermined length, and the speed planning unit may be configured to plan a speed of the mobile apparatus on the local route.

The speed planning unit may be configured to generate speed information for causing the mobile apparatus to stop at the end point of the route extended by the predetermined length.

The map information of the travel environment may include information regarding presence/absence of the obstacle present in a periphery of the movable object, and the speed planning unit may be configured to generate, in a case where the obstacle is present on a route of the route extended by the predetermined length, speed information for causing the mobile apparatus to stop just before collision with the obstacle.

The sub-goal setting unit may be configured to set a sub-goal capable of avoiding collision with the obstacle, and the speed planning unit may be configured to plan a speed of the mobile apparatus at the end point of the route extended by the predetermined length from the sub-goal capable of avoiding collision with the obstacle.

The speed planning unit may be configured to plan a speed of the mobile apparatus at an end point of a route extended in a predetermined direction.

The predetermined direction may be a forward direction of the mobile apparatus.

The speed planning unit may be configured to generate speed information for causing the mobile apparatus to decelerate to obtain the planned speed at the end point of the extended line segment.

The information processing apparatus may further include a general-route planning unit that plans a general route of the mobile apparatus on the basis of the position information of the destination.

The information processing apparatus may be provided in the mobile apparatus.

An information processing method according to an embodiment of the present technology includes:

setting a sub-goal on the basis of environment information including position information of a set destination, map information of a travel environment of a mobile apparatus, and self-position information of the mobile apparatus;

planning a movement route of the mobile apparatus on the basis of the sub-goal; and

planning a speed of the mobile apparatus at an end point of a route extended by a predetermined length from the sub-goal.

A program according to an embodiment of the present technology causes a computer to executes:

a step of setting a sub-goal on the basis of environment information including position information of a set destination, map information of a travel environment of a mobile apparatus, and self-position information of the mobile apparatus;

a step of planning a movement route of the mobile apparatus on the basis of the sub-goal; and

a step of planning a speed of the mobile apparatus at an end point of a route extended by a predetermined length from the sub-goal.

### BRIEF DESCRIPTION OF DRAWINGS

FIG. 1 A schematic configuration diagram of a mobile apparatus according to an embodiment of the present technology.

FIG. 2 A functional block diagram of a controller in the mobile apparatus.

FIG. 3 An explanatory diagram showing actions of the controller.

FIG. 4 An explanatory diagram showing actions of the controller.

FIG. 5 A flowchart showing an example of processing performed in the controller.

FIG. 6 An explanatory diagram showing actions of the controller.

FIG. 7 An explanatory diagram showing actions of the controller.

FIG. 8 An explanatory diagram showing actions of the controller.

### MODE(S) FOR CARRYING OUT THE INVENTION

Hereinafter, an embodiment according to the present technology will be described with reference to the drawings.

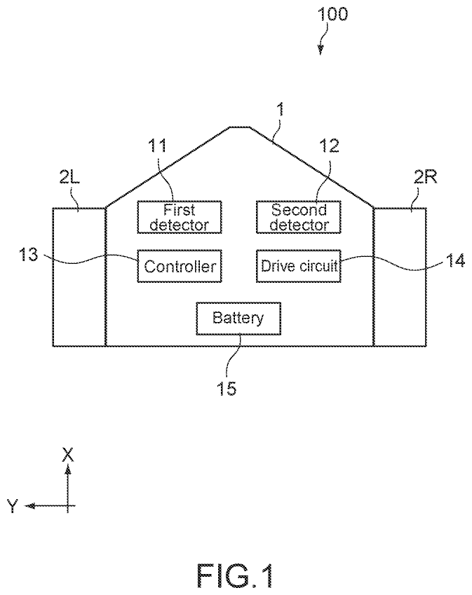

FIG. 1 is a schematic configuration diagram of a mobile apparatus according to the embodiment of the present technology. A mobile apparatus 100 according to this embodiment is configured as a two-wheel differential drive-type robot having a body 1 and wheels (right wheel 2R and left wheel 2L), which is an autonomous movable object. It should be noted that the present technology is not limited thereto, and the present technology can also be applied to another autonomous movable object such as a walking robot and a drone.

The X- and Y-axes in FIG. 1 indicate front-rear and left-right directions of the mobile apparatus 100, respectively, and the upper side in the figure corresponds to a front side of the mobile apparatus 100. The mobile apparatus 100 is configured to be autonomously movable to a destination along a route set on the basis of position information of the destination, map information of a travel environment of the mobile apparatus 100, and self-position information of the mobile apparatus 100, for example. The mobile apparatus 100 is configured as, for example, a self-driving vehicle that goes around a predetermined route, an unmanned transportation apparatus that transports articles to a predetermined destination, or the like.

[Mobile Apparatus]

First of all, a configuration of the mobile apparatus 100 will be schematically described. As shown in FIG. 1, the mobile apparatus 100 includes a first detector 11, a second detector 12, a controller 13, a drive 14, a battery 15, and the like and they are arranged in an inner or outer surface of the body 1.

The first detector 11 is a detector for acquiring information regarding the self-position and attitude of the mobile apparatus 100 (hereinafter, also referred to as self-position information). Examples of the first detector 11 can include a combination of a global positioning system (GPS) antenna and an inertial measurement unit (IMU). In addition, examples of the first detector 11 can include a camera and a technology using simultaneous localization and mapping (SLAM) for calculating the self-position on the basis of information regarding feature points of a captured image of the camera can be employed.

The second detector 12 is an detector for acquiring information regarding the position of an obstacle in a periphery of the mobile apparatus 100 (hereinafter, also referred to as obstacle map information). The obstacle set forth herein refers to a tangible object such as a person, an object, and a wall, which can be an obstacle against the movement of the mobile apparatus 100. The obstacle is not limited to a stationary obstacle, and may be a movable obstacle. The second detector 12 is typically installed on the outer surface of the body 1 of the mobile apparatus 100. For example, a laser range finder, an ultrasonic sensor, a stereo camera, or a combination thereof may be used as the second detector 12.

The controller 13 is configured as a computer (information processing apparatus) having a central processing unit (CPU), a memory, and the like. As will be described later, on the basis of the self-position information, the obstacle map information, and the like, the controller 13 plans a movement route of the mobile apparatus 100 to the destination and generates various control commands for executing it.

It should be noted that instead of or in addition to the CPU, a programmable logic device (PLD) such as a field programmable gate array (FPGA), a digital signal processor (DSP), another application specific integrated circuit (ASIC), or the like may be used.

The drive 14 includes a motor that rotates the wheels 2R and 2L, a drive circuit that drives the motor, and the like. The drive 14 individually controls rotation (direction of rotation, number of rotations, and the like) of each of the wheels 2R and 2L on the basis of a control command from the controller 13.

The battery 15 is configured as a power source for the mobile apparatus 100. The battery 15 is typically a secondary battery capable of charging and discharging. Alternatively, a solar battery or the like other than the secondary battery may be used as the battery 15.

[Information Processing Apparatus]

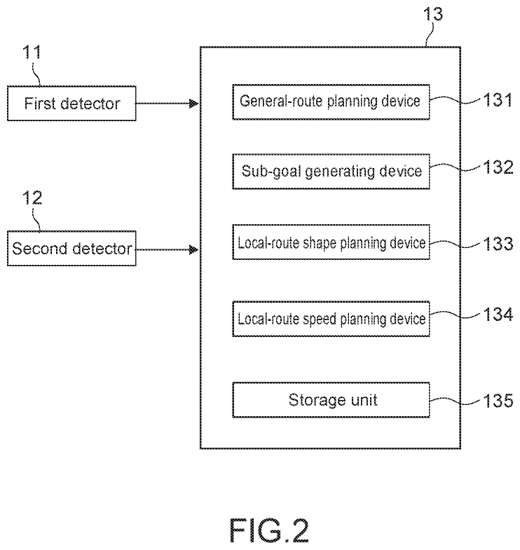

Subsequently, the controller 13 will be described in detail. FIG. 2 is a block diagram showing functions of the CPU that constitutes the controller 13.

As shown in FIG. 2, the controller 13 includes a general-route planning device 131 (general-route planning unit), a sub-goal generating device 132 (sub-goal setting unit), a local-route shape planning device 133 (local-route planning unit), a local-route speed planning device 134 (speed planning unit), and a storage unit 135.

The controller 13 controls the first detector 11, the second detector 12, and the drive 14. In this embodiment, when the CPU executes a predetermined program, the general-route planning device 131, the sub-goal generating device 132, the local-route shape planning device 133, and the local-route speed planning device 134 as functional blocks are configured. As a matter of course, dedicated hardware such as an integrated circuit (IC) may be used in order to realize the respective blocks. The program is installed in the controller 13 via various types of storage media, for example. Alternatively, the program may be installed via the Internet or the like.

The general-route planning device 131 plans a general route to the destination on the basis of the position information of the destination (general goal). The calculation method for the general route is not particularly limited, and an appropriate route planning algorithm may be used.

The position information of the destination is set and stored in the storage unit 135 in advance together with the map information in which the destination is located. The destination may prescribe the attitude of the mobile apparatus 100 when the mobile apparatus 100 arrives at the destination as well as the position on the map information. The general route is not limited to a linear route, and may include bent portions and curve portions. The general-route planning device 131 generates general-route information indicating the general route and stores the general-route information in the storage unit 135. The general-route information may be embedded in the map information including the destination.

The position on the map information prescribed as the destination indicates a position set as coordinates on the map information, at which a predetermined task assigned to the mobile apparatus is performed. The predetermined task includes, for example, loading, unloading, sensing through a mounted sensor, charging, standing by for a predetermined period until a next task is assigned, and the like.

The position on the map information is typically set as coordinates of a two-dimensional space on the map information with respect to a mobile apparatus that travels the ground, and is set as coordinates of a three-dimensional space with respect to a mobile apparatus that flies. Moreover, in a case where the map information has information regarding three-dimensional coordinates, the position on the map information may be set as coordinates of a three-dimensional space even with respect to the mobile apparatus that travels the ground. Moreover, a predetermined grid-like region or space may be set.

The attitude of the mobile apparatus prescribed as the destination is typically described as a direction of the body of the mobile apparatus for the purpose as will be described below. Moreover, a yaw angle, a gyro angle, a pitch angle, a steering angle, or the like may be considered and given priority or a setting to use only them may be made.

The sub-goal generating device 132 arranges a sub-goal on the basis of environment information including the position information of the set destination, the map information of the travel environment of the mobile apparatus 100, and the self-position information of the mobile apparatus 100.

The sub-goal refers an end point of a local-route plan and is for determining a reference position of the local-route plan. The sub-goal is arranged on the general route or the vicinity thereof so that the mobile apparatus 100 can arrive at the destination in a prescribed attitude. Not only the position information but also information that prescribes speed and attitude of the mobile apparatus 100 are embedded for the sub-goal. A method of setting the sub-goal is not particularly limited, and an appropriate route planning algorithm may be used. The set sub-goal is stored in the storage unit 135 as sub-goal information. The sub-goal may also be set as the coordinates of the three-dimensional space or the predetermined grid-like region or space as in destination.

The position information of the destination is map information including the general-route information. The map information of the travel environment of the mobile apparatus 100 is map information created on the basis of information regarding the position and size of the obstacle, which is acquired by the second detector 12. The self-position information of the mobile apparatus 100 is map information regarding the self-position of the mobile apparatus 100 acquired by the first detector 11. The map information of the travel environment and the self-position information are acquired from the second detector 12 and the first detector 11 in a predetermined time cycle and stored in the storage unit 135. Such information may be successively embedded in the map information including the destination together with the general-route information.

The local-route shape planning device 133 plans a movement route (local route) to the sub-goal on the basis of the sub-goal information generated by the sub-goal generating device 132. The local route is a route to move the mobile apparatus 100 toward the sub-goal set by the sub-goal generating device 132. The planned local route is stored in the storage unit 135 as local-route information. The calculation method for the local route is not particularly limited, and an appropriate route planning algorithm can be used. The sub-goal information and the local-route information are successively generated in the predetermined time cycle until the mobile apparatus 100 arrives at the destination G.

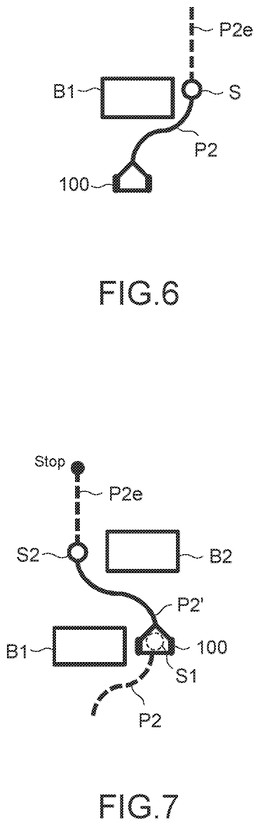

In addition, the local-route shape planning device 133 is configured to be capable of setting the route extended by the predetermined length from the sub-goal. For example, as schematically shown in FIG. 6, the local-route shape planning device 133 sets a local route P2 that avoids collision with an obstacle B1 and reaches a set sub-goal S and an extended route P2e that extends in a predetermined direction (to the front side of the mobile apparatus 100 in the shown example) from the sub-goal S. The length of the extended route P2e is not particularly limited, and can be set to have an arbitrary length. The extended route P2e is not limited to the linear route, and may be a curve route.

The local-route speed planning device 134 plans a speed of the mobile apparatus 100 on the sub-goal set by the sub-goal generating device 132. The planned speed information is embedded in the sub-goal information set by the sub-goal generating device 132.

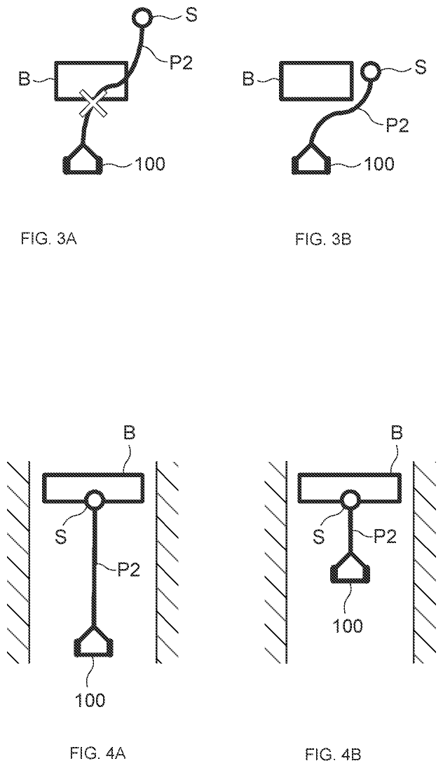

Although the distance (route length) of the local route is not particularly limited, the distance (route length) of the local route is favorably set to a distance capable of avoiding collision with the obstacle without rapid deceleration even in a case where an obstacle is found. For example, the performance for avoiding an obstacle B is higher in a case where the route length of the local route P2 is relatively short as shown in FIGS. 3 (b) and 4 (b) than in a case where the route length of the local route P2 is relatively long as shown in FIGS. 3 (a) and 4 (a). Moreover, a local route having high performance for avoiding the obstacle B can be planned by narrowing the arrangement interval of the sub-goal S.

In addition, as will be described later, when the extended route P2e (see FIG. 6) extending from the sub-goal is set in the local-route shape planning device 133, the local-route speed planning device 134 is configured to generate speed information for causing the mobile apparatus 100 to stop (have zero speed) at the end point of the extended route. In this case, speed information for causing the mobile apparatus 100 to decelerate to obtain the planned speed at the end point of the extended route P2e may be generated. Accordingly, since the mobile apparatus 100 passes through the set sub-goal while decelerating, even in a case where the mobile apparatus 100 is incapable of avoiding collision with an unknown obstacle on the front side before then, it is possible to cause the mobile apparatus 100 to smoothly stop without rapid deceleration.

The storage unit 135 is typically constituted by a storage device such as a semiconductor memory. The storage unit 135 stores various parameters for calculating the general route, the sub-goal, the local-route shape, and the local-route speed in addition to the program for executing various functions of the general-route planning device 131, the sub-goal generating device 132, the local-route shape planning device 133, and the local-route speed planning device 134.

More specifically, the storage unit 135 stores a program that causes the controller 13 serving as the computer to execute a step of setting the sub-goal on the basis of the environment information including the position information of the set destination, the map information of the travel environment of the mobile apparatus, and the self-position information of the mobile apparatus, and a step of planning the movement route of the mobile apparatus on the basis of the sub-goal, and a step of planning a speed of the mobile apparatus at the end point of the route extended by the predetermined length from the sub-goal.

[Information Processing Method]

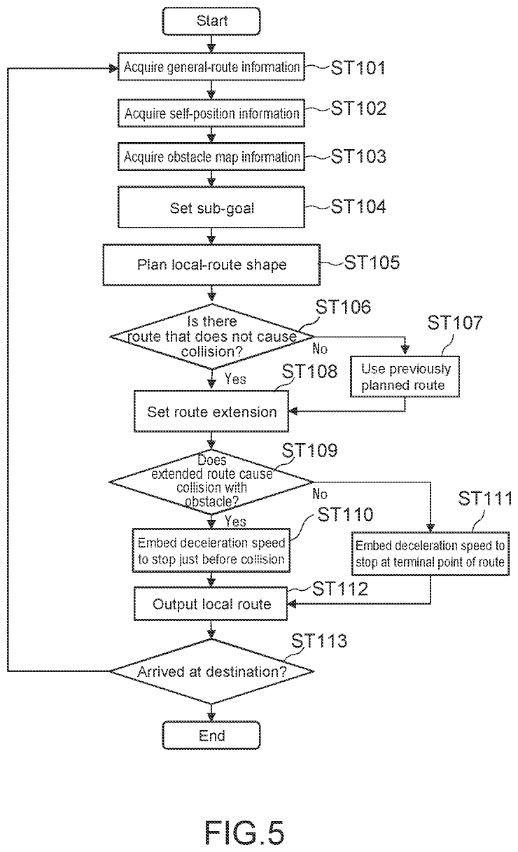

Subsequently, the controller 13 will be described in detail along with an operation of the controller 13. FIG. 5 is a flowchart showing an example of processing performed in the controller 13 and FIGS. 6 to 8 are explanatory diagrams actions of the controller 13.

The controller 13 acquires general-route information from the storage unit 135 (Step 101). The general-route information is for acquiring the position of the destination and a generation position of a sub-goal S. The general-route information is map information indicating a route to the position of the set destination, and includes information regarding a general route determined by the general-route planning device 131 and information regarding the attitude of the mobile apparatus 100 (orientation) on the destination. The general route is determined in the general-route planning device 131 and the sub-goal S is set in the sub-goal generating device 132 as will be described later.

Moreover, the controller 13 acquires self-position information (Step 102). The self-position information is for determining the setting position of the sub-goal S and the reference position of the local-route plan. The self-position information includes information regarding the current position of the mobile apparatus 100, which is acquired by the first detector 11.

In addition, the controller 13 acquires obstacle map information (Step 103). The obstacle map information is for determining the setting position of the sub-goal S and planning the local-route that avoids the obstacle. The obstacle map information includes information regarding the position and the size of the obstacle in the periphery of the mobile apparatus 100, which are acquired by the second detector 12.

It should be noted that Steps 101 to 103 are not limited to the example in which they are performed in this order, and these steps may be simultaneously performed. The general-route information, the self-position information, and the obstacle map information may be the general route, the self-position of the mobile apparatus 100, and the position of the obstacle commonly embedded in a single map. Moreover, as will be described later, the first detector 11 and the second detector 12 acquire the self-position and the obstacle information in the predetermined time cycle, respectively. Accordingly, the self-position information and the obstacle map information are updated in accordance with the movement position of the mobile apparatus 100.

Subsequently, the sub-goal generating device 132 sets the sub-goal (Step 104). In this case, the sub-goal generating device 132 may generate the plurality of sub-goal candidates. The sub-goal candidates refer to a plurality of candidate points to be selected as the sub-goal. The respective sub-goal candidates are prioritized. Typically, a candidate point that can provide the shortest route to the destination is selected. In a case where the presence of the obstacle has been detected, a sub-goal capable of avoiding collision with the obstacle is set (see FIG. 6).

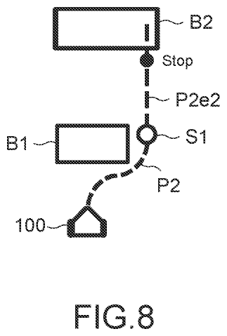

Subsequently, the local-route shape planning device 133 plans the shape of the local route that reaches the set sub-goal on the basis of the sub-goal information and the self-position, the obstacle map, and the like generated in the sub-goal generating device 132 (Step 105). Here, as shown in FIGS. 7 and 8, the local route P2 to a sub-goal S1 capable of avoiding the immediate obstacle (first obstacle B1) is planned.

Next, in a case where there is another obstacle (second obstacle B2) at the back of the first obstacle B1, the local-route shape planning device 133 determines whether or not there is a route capable of avoiding collision with the second obstacle B2 (Step 106). For example, in a case where there is a route P2′ capable of avoiding the second obstacle B2 as shown in FIG. 7, it is determined that “the route that does not cause collision is present”, and in a case where the route capable of avoiding the second obstacle B2 is absent as shown in FIG. 8, it is determined that “the route that does not cause collision is absent”.

In a case where it is determined that “the route that does not cause collision is present” (Yes in Step 106), the local-route shape planning device 133 sets the extended route P2e extending forward, which is the travel direction of the mobile apparatus 100, from a sub-goal S2 that is the end point of the route P2′ (Step 108).

On the other hand, in a case where it is determined that “the route that does not cause collision is absent” (No in Step 106), the local-route shape planning device 133 sets the extended route P2e extending forward from the sub-goal S1 that is its end point by using the previously planned local route P2 (Steps 107 and 108).

Subsequently, the local-route speed planning device 134 plans a speed of the mobile apparatus 100 at the end point of the extended route P2e. In this embodiment, it is determined whether or not the extended route P2e causes collision with the obstacle (Step 109). In the example of FIG. 8, in a case where the distance between the sub-goal S1 to the second obstacle B2 is shorter than the length of the extended route P2e, it is determined that the extended route P2e causes collision with the obstacle.

In a case where it is determined that the extended route P2e causes collision with the obstacle (Yes in Step 109), the local-route speed planning device 134 generates speed information for causing the mobile apparatus 100 to stop just before collision with the obstacle (Step 110). In the example of FIG. 8, speed information for causing the mobile apparatus 100 to decelerate to obtain zero speed just before collision with the second obstacle B2 is generated.

Accordingly, since the mobile apparatus 100 travels on the route P2′ while decelerating, also in a case where a new obstacle has been detected beyond the route P2′, it is possible to cause the mobile apparatus 100 to smoothly stop without rapid deceleration. Moreover, also in a case where the second obstacle B2 is a movable obstacle such as a person, such an effect can avoid the collision without requiring rapid deceleration.

On the other hand, in a case where it is determined that the extended route P2e does not cause collision with the obstacle (No in Step 109), the local-route speed planning device 134 generates speed information for causing the mobile apparatus 100 to stop at the end point of the extended route P2e (Step 111). In the example of FIG. 7, speed information for causing the mobile apparatus 100 to decelerate to obtain zero speed at the end point of the extended route P2e obtained by extending the route P2′ capable of avoiding the second obstacle B2 is generated. In this case, the speed is not limited to zero, and may be an arbitrary speed around zero. It should be noted that in a case where the distance between the sub-goal S1 to the second obstacle B2 is longer than the length of the extended route P2e in FIG. 8, speed information for causing the mobile apparatus 100 to decelerate to obtain zero speed at the end point of the extended route P2e is generated.

In this case, since the mobile apparatus 100 travels on the route P2 while decelerating, also in a case where the distance between the sub-goal S1 to the second obstacle B2 is relatively short, it is possible to cause the mobile apparatus 100 to gently stop just before the second obstacle B2 without rapid deceleration.

The local-route information including the shape and speed of the local route is generated in the above-mentioned manner. The controller 13 outputs a control signal for controlling the number of rotations and the directions of rotations of the wheels 2R and 2L to the drive 14 on the basis of the generated local-route information, to thereby advance the mobile apparatus 100 at a predetermined speed and move the mobile apparatus 100 along the local route P2 (Step 112). Each of the above-mentioned steps is repeatedly performed until the mobile apparatus 100 arrives at the destination (Step 113).

As described above, the local-route speed planning device 134 according to this embodiment is configured to plan a speed of the mobile apparatus 100 at a distance different from the distance of the local route (not including the extended route) planned by the local-route shape planning device 133. More specifically, the local-route speed planning device 134 is configured to plan a speed of the mobile apparatus 100 that moves on the local route on the basis of the speed of the mobile apparatus 100 at the end point of the extended route from the set sub-goal. Accordingly, even in a case where an obstacle hidden behind the immediate obstacle for the first time after avoiding the immediate obstacle has been detected, a smooth response without rapid deceleration can be performed. Therefore, the load (inertial force) added to a passenger, an article to be transported, or the like in the mobile apparatus 100 can be reduced.

### Modified Examples

In the above-mentioned embodiment, the example in which the controller 13 is provided in the mobile apparatus 100 has been described, though the controller 13 may be installed in a place other than the mobile apparatus 100. In this case, control information such as the general-route information, the sub-goal information, and the local-route information with respect to the mobile apparatus 100 is sent to the controller 13 via wireless communication. Moreover, in this case, the controller 13 may be configured to control the movement of a plurality of mobile apparatuses 100.

Moreover, the speed of the mobile apparatus 100 is planned after the local route including the extended route P2e set by the local-route shape planning device 133 is planned, though not limited thereto. For example, the extended route P2e may be set when the speed of the mobile apparatus 100 in the local-route speed planning device 134 is planned, and the set extended route may be removed after generation of the speed information. Accordingly, the amount of data of the route corresponding to the extended route can be reduced.

Moreover, in the above-mentioned embodiment, in a case where it is determined that the route that does not cause collision with the obstacle is absent, the previously planned route is adopted and the extended route of the local route is set, though not limited thereto. For example, a database that stores routes adopted as an avoidance route during a past constant period may be installed and one route of the routes may be used or a plurality of routes of the routes may be used in combination. Accordingly, there is a possibility that a new avoidance route can be found.

In addition, in the above-mentioned embodiment, in a case where it is determined that the route that does not cause collision with the obstacle is absent, speed information for causing the speed to be zero just before the obstacle or at the end point of the extended route is generated, though not limited thereto. For example, the direction in which the extended route extends may be formed in a curved shape so as to avoid the obstacle sideways rather than forming the direction in which the extended route extends linearly toward the obstacle. In this case, an arbitrary speed change can be set in accordance with the surrounding environment such as the shape of the obstacle.

It should be noted that the present technology may also take the following configurations.

(1) An information processing apparatus, including:

a sub-goal setting unit that sets a sub-goal on the basis of environment information including position information of a set destination, map information of a travel environment of a mobile apparatus, and self-position information of the mobile apparatus;

a local-route planning unit that plans a movement route of the mobile apparatus on the basis of the sub-goal; and

a speed planning unit that plans a speed of the mobile apparatus at an end point of a route extended by a predetermined length from the sub-goal.

(2) The information processing apparatus according to (1), in which

the local-route planning unit plans a local route including the route extended by the predetermined length, and

the speed planning unit plans a speed of the mobile apparatus on the local route.

(3) The information processing apparatus according to (2), in which

the speed planning unit generates speed information for causing the mobile apparatus to stop at the end point of the route extended by the predetermined length.

(4) The information processing apparatus according to (1) or (2), in which

the map information of the travel environment includes information regarding presence/absence of the obstacle present in a periphery of the movable object, and

the speed planning unit generates, in a case where the obstacle is present on a route of the route extended by the predetermined length, speed information for causing the mobile apparatus to stop just before collision with the obstacle.

(5) The information processing apparatus according to (4), in which

the sub-goal setting unit sets a sub-goal capable of avoiding collision with the obstacle, and

the speed planning unit plans a speed of the mobile apparatus at the end point of the route extended by the predetermined length from the sub-goal capable of avoiding collision with the obstacle.

(6) The information processing apparatus according to any one of (1) to (5), in which

the speed planning unit plans a speed of the mobile apparatus at an end point of a route extended in a predetermined direction.

(7) The information processing apparatus according to (6), in which

the predetermined direction is a forward direction of the mobile apparatus.

(8) The information processing apparatus according to any one of (1) to (7), in which

the speed planning unit generates speed information for causing the mobile apparatus to decelerate to obtain the planned speed at the end point of the extended line segment.

(9) The information processing apparatus according to any one of (1) to (8), further including

a general-route planning unit that plans a general route of the mobile apparatus on the basis of the position information of the destination.

(10) The information processing apparatus according to any one of (1) to (9), in which

the information processing apparatus is provided in the mobile apparatus.

(11) An information processing method, including:

setting a sub-goal on the basis of environment information including position information of a set destination, map information of a travel environment of a mobile apparatus, and self-position information of the mobile apparatus;

planning a movement route of the mobile apparatus on the basis of the sub-goal; and

planning a speed of the mobile apparatus at an end point of a route extended by a predetermined length from the sub-goal.

(12) A program that causes a computer to executes:

a step of setting a sub-goal on the basis of environment information including position information of a set destination, map information of a travel environment of a mobile apparatus, and self-position information of the mobile apparatus;

a step of planning a movement route of the mobile apparatus on the basis of the sub-goal; and

a step of planning a speed of the mobile apparatus at an end point of a route extended by a predetermined length from the sub-goal.

### REFERENCE SIGNS LIST

11 first detector
12 second detector
13 controller
14 drive
100 mobile apparatus
131 general-route planning device
132 sub-goal generating device
133 local-route shape planning device
134 local-route speed planning device
135 storage unit
B, B1, B2 obstacle
P2, P2′ local route
P2e extended route
S, S1, S2 sub-goal

1. An information processing apparatus, comprising:
a sub-goal setting unit that sets a sub-goal on a basis of environment information including position information of a set destination, map information of a travel environment of a mobile apparatus, and self-position information of the mobile apparatus;
a local-route planning unit that plans a movement route of the mobile apparatus on a basis of the sub-goal; and
a speed planning unit that plans a speed of the mobile apparatus at an end point of a route extended by a predetermined length from the sub-goal.

2. The information processing apparatus according to claim 1, wherein
the local-route planning unit plans a local route including the route extended by the predetermined length, and
the speed planning unit plans a speed of the mobile apparatus on the local route.

3. The information processing apparatus according to claim 2, wherein
the speed planning unit generates speed information for causing the mobile apparatus to stop at the end point of the route extended by the predetermined length.

4. The information processing apparatus according to claim 1, wherein
the map information of the travel environment includes information regarding presence/absence of the obstacle present in a periphery of the movable object, and
the speed planning unit generates, in a case where the obstacle is present on a route of the route extended by the predetermined length, speed information for causing the mobile apparatus to stop just before collision with the obstacle.

5. The information processing apparatus according to claim 4, wherein
the sub-goal setting unit sets a sub-goal capable of avoiding collision with the obstacle, and
the speed planning unit plans a speed of the mobile apparatus at the end point of the route extended by the predetermined length from the sub-goal capable of avoiding collision with the obstacle.

6. The information processing apparatus according to claim 1, wherein
the speed planning unit plans a speed of the mobile apparatus at an end point of a route extended in a predetermined direction.

7. The information processing apparatus according to claim 6, wherein
the predetermined direction is a forward direction of the mobile apparatus.

8. The information processing apparatus according to claim 1, wherein
the speed planning unit generates speed information for causing the mobile apparatus to decelerate to obtain the planned speed at the end point of the extended line segment.

9. The information processing apparatus according to claim 1, further comprising
a general-route planning unit that plans a general route of the mobile apparatus on a basis of the position information of the destination.

10. The information processing apparatus according to claim 1, wherein
the information processing apparatus is provided in the mobile apparatus.

11. An information processing method, comprising:
setting a sub-goal on a basis of environment information including position information of a set destination, map information of a travel environment of a mobile apparatus, and self-position information of the mobile apparatus;
planning a movement route of the mobile apparatus on a basis of the sub-goal; and
planning a speed of the mobile apparatus at an end point of a route extended by a predetermined length from the sub-goal.

12. A program that causes a computer to executes:
a step of setting a sub-goal on a basis of environment information including position information of a set destination, map information of a travel environment of a mobile apparatus, and self-position information of the mobile apparatus;
a step of planning a movement route of the mobile apparatus on a basis of the sub-goal; and
a step of planning a speed of the mobile apparatus at an end point of a route extended by a predetermined length from the sub-goal.
